(19) United States
(12) Patent Application Publication
(10) Pub. No.: US 2005/0049014 A1
(43) Pub. Date: Mar. 3, 2005

(54) Wireless local area network device

(75) Inventor: Ou Tunlin Nelson, Palo Alto, CA (US)

Correspondence Address: BACON & THOMAS, PLLC, 625 SLATERS LANE, FOURTH FLOOR, ALEXANDRIA, VA, 22314, US

(73) Assignee: WavePlus Technology Co., Ltd., Taipei (TW)

(21) Appl. No.: 10/703,601

(22) Filed: Nov. 10, 2003

(30) Foreign Application Priority Data
Aug. 28, 2003 (TW) 092123818

(51) Int. Cl. H04M 1/00

(52) U.S. Cl. 455/575.1

(57) ABSTRACT

This disclosure represents an improvement upon a wireless LAN device design for the purposes of antenna positioning and ease of use. The wireless LAN device consists of four parts: a body, a cover, a revolving member, and an antenna. The body has a connector for connecting with a connector of a separate device in a detachable manner. The cover connects with the body in a sliding manner, exposing or covering the connector. The revolving member is connected to the antenna in a fixed manner and connected to the body in a revolving manner.

### BACKGROUND OF THE INVENTION

1. Field of the Invention

The present invention relates to a wireless local area network (LAN) device and, more particularly, to a wireless LAN device capable of arbitrarily adjusting an antenna direction and protecting a connector of the antenna.

2. Description of Related Art

A conventional arrangement of a plurality of computers being communicable wirelessly is shown in FIG. 1. One computer 11 is capable of accessing the Internet via an ADSL (Asymmetric Digital Subscriber Line) or cable modem and comprises a wireless access point 18. Each of computers 12, 13, and 14 comprises a wireless adapter 19 for communicating with the wireless access point 18 in a wireless manner. Consequently, all computers 11, 12, 13, and 14 are coupled together wirelessly as a local network and also are capable of accessing the Internet.

Portable wireless products are commercially available due to the downsizing of electronic devices. A prior USB (Universal Serial Bus) wireless adapter is shown in FIGS. 2 and 3. The wireless adapter comprises a body 21, an antenna 22 pivotably coupled to one side of the body 21, and a USB connector 23 at the other side of the body 21. In operation, the antenna 22 is pivoted about 90 degrees with respect to the body 21, and then the USB connector 23 is inserted in a slot of a computer 31. However, the prior art suffered from several disadvantages. For example, the antenna direction is restricted by the orientation of the computer 31. Thus, it is often that an optimum receiving quality of signal sent from an antenna of the wireless access point to the antenna 22 of the USB wireless adapter cannot be obtained. A solution of the above is to adjust the direction of the computer 31 but it is cumbersome and inconvenient to do so. Moreover, improvements of receiving quality of the antenna of the wireless access point are important because the antenna is responsible for communicating with a plurality of wireless adapters. However, the prior art does not satisfy the needs of the current market. Therefore, it is desirable to provide a novel wireless adapter and wireless access point in order to mitigate and/or obviate the aforementioned problems.

### SUMMARY OF THE INVENTION

An object of the present invention is to provide a wireless LAN device capable of arbitrarily adjusting the direction of its antenna for obtaining an optimum communication quality.

Another object of the present invention is to provide a wireless LAN device capable of protecting a connector of the LAN device.

In accordance with one aspect of the present invention, there is provided a wireless local area network device, which comprises: a body including a base at its rear part, the base defining an accommodating space therein; a connector arranged at a front part of the housing; a revolving member rotatably arranged in the accommodating space of the base; and an antenna integrally connected to the revolving member, and capable of adjusting its direction by rotating the revolving member.

In accordance with another aspect of the present invention, there is provided a wireless local area network device, which comprises: a body including a PCB; an antenna arranged at a rear part of the housing, and electrically coupled to the PCB; a connector arranged at a front part of the housing, and electrically coupled to the PCB; and a cover slidably connected to the housing, the cover having a opening, wherein when being slid to a first position, the cover covers the connector, and when being slid to a second position, the hole of the cover exposes the connector.

Other objects, advantages, and novel features of the invention will become more apparent from the detailed description when taken in conjunction with the accompanying drawings.

### BRIEF DESCRIPTION OF THE DRAWINGS

FIG. 1 schematically illustrates a prior wireless local area network;

FIG. 2 is a perspective view of a prior USB wireless adapter;

FIG. 3 is a perspective view showing the USB wireless adapter to be inserted in a computer;

FIG. 4 is a perspective view of a preferred embodiment of wireless LAN device in accordance with the invention;

FIG. 5 is another perspective view of the wireless LAN device in accordance with the invention;

FIG. 6 is a partial cross-sectional view of the wireless LAN device in accordance with the invention; and

FIG. 7 is another partial cross-sectional view of the wireless LAN device in accordance with the invention.

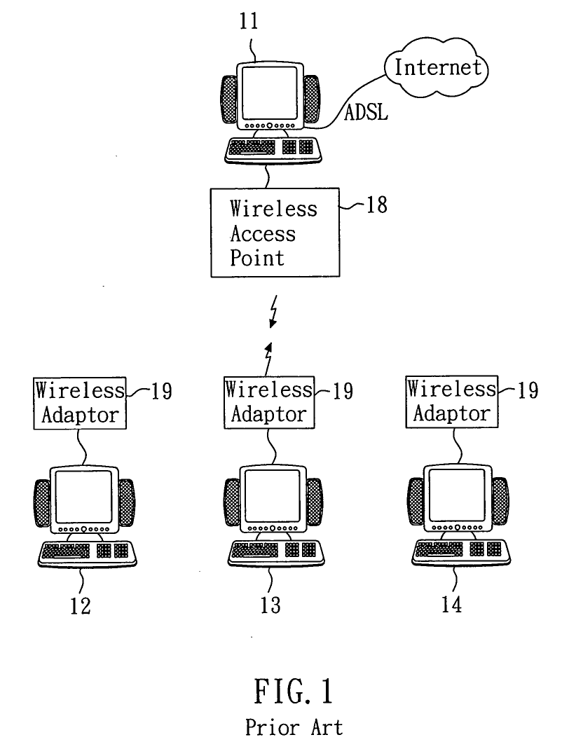

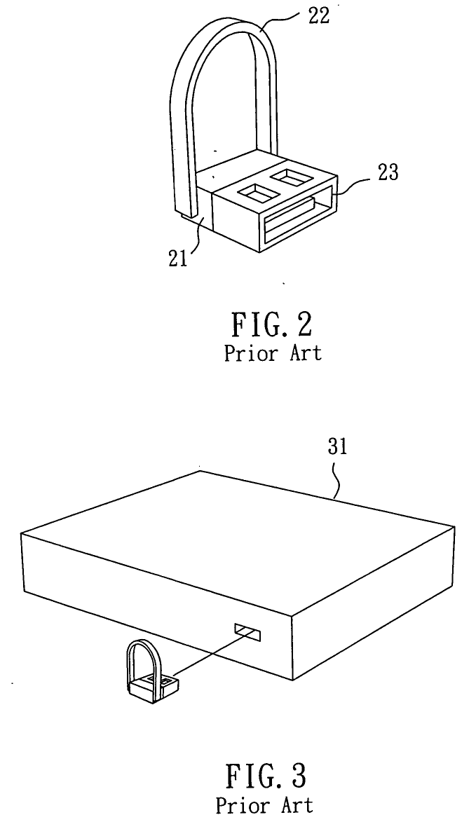

### DETAILED DESCRIPTION OF THE PREFERRED EMBODIMENT

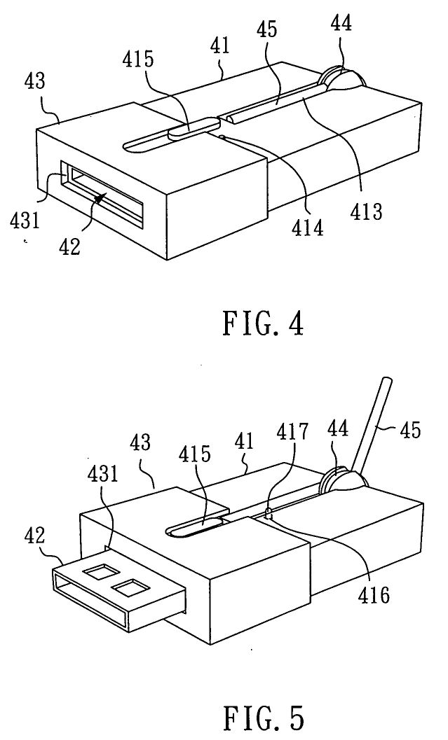

With reference to FIG. 4, there is shown a wireless local area network (LAN) device in accordance with the invention, which includes a body 41, a connector 42, a cover 43, a revolving member 44, and an antenna 45. The connector 42 is arranged at a front side of the body 41. The connector 42 is preferred to be a USB connector. The cover 43 is slidably connected to the body 41, and has an opening 431, so that when being slid to a first position, the cover 43 covers the connector 42 (as shown in FIG. 4) thereby protecting the connector 42, and when being slid to a second position (as shown in FIG. 5), the opening 431 of the cover 43 exposes the connector 42 thereby allowing the connector 42 to be used.

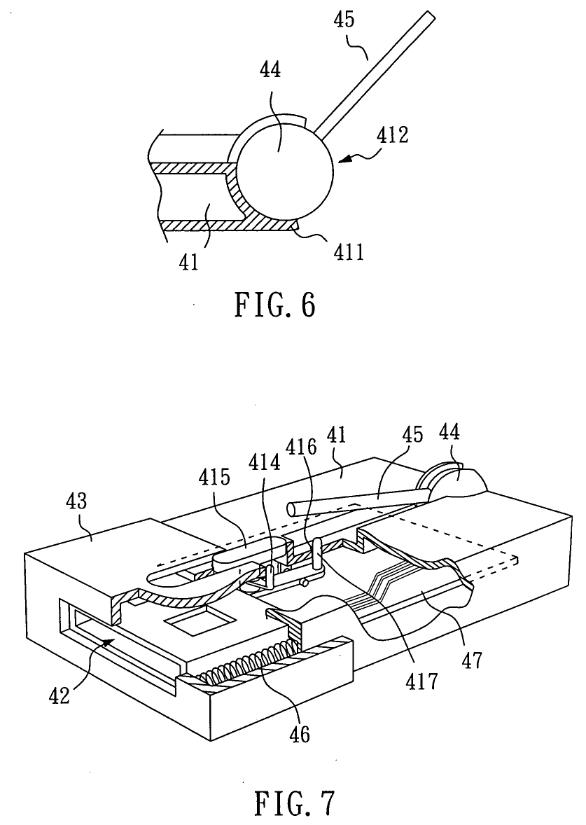

FIG. 6 shows a partial cross-sectional view of the wireless LAN device in accordance with the present invention. As shown, the body 41 has a base 411 at its rear part. The base 411 has an accommodating space 412 for receiving the revolving member 44. The accommodating space has an arc-shape to enable the revolving member 44 therein to be arbitrarily rotated. The antenna 45 is integrally connected to the revolving member 44. Therefore, the antenna 45 can be adjusted to point to any direction by rotating the revolving member 44.

With reference to FIGS. 4 and 5, the body has a slit 413 for receiving the antenna 45. The antenna 45 is received in the slit 413 when not in use, so as to protect the antenna 45. Also with reference to FIG. 7 showing a partial cross-sectional view of the wireless LAN device, an extensible spring 46 is provided between one side of the body 41 and the cover 43. The two ends of the extensible spring 46 are fixed to the body 41 and the cover 43, respectively. When the extensible spring 46 is not extended, the cover 43 is in the second position. When the extensible spring 46 is extended, the cover 43 is in the first position. The body 41 further comprises a locking pin 414. The locking pin 414 will project upward to lock the cover 43 on the body 41 when the spring 46 is extended and the cover 43 is slid to the first position.

FIGS. 4, 5 and 6 also show that the body 41 further comprises a push button 415 on the top adjacent the locking pin 414. When the push button 415 is pressed, the locking pin 414 is pushed down to return the extensible spring 46 to its original state, thereby sliding the cover 43 to the second position for exposing the connector 42. In addition, a hole 416 is provided in the slit 413, and a push pin 417 is disposed in the hole 416. The push pin 417 is activated by pressing the push button 415 for pushing the antenna 45 out of the slit 413.

FIG. 7 shows that a PCB (printed circuit board) 47 is mounted in the body 41. The PCB 47 is electrically coupled to both the revolving member 44 and the connector 42. A soft wire (not shown) can be provided in the revolving member 44 for sending signals received from the antenna 45 to the PCB 47 or sending signals from the PCB 47 to the antenna 45 for transmission.

The PCB 47 of the wireless LAN device in accordance with the present invention can be mounted with the circuitry of a wireless access point for configuring the wireless LAN device as a wireless access point. Alternatively, the PCB can be mounted with an adapter circuitry for configuring the wireless LAN device as a wireless adapter device.

Although the present invention has been explained in relation to its preferred embodiment, it is to be understood that many other possible modifications and variations can be made without departing from the spirit and scope of the invention as hereinafter claimed.

1. A wireless local area network device, comprising:
a body including a base at its rear part, the base defining an accommodating space therein;
a connector arranged at a front part of the housing;
a revolving member rotatably arranged in the accommodating space of the base; and
an antenna integrally connected to the revolving member, and a direction of the antenna being adjustable by rotation of the revolving member.

2. The wireless local area network device as claimed in claim 1, further comprising a cover slidably connected to the housing, the cover having an opening.

3. The wireless local area network device as claimed in claim 2, wherein the cover is slid to a first position for covering the connector, and the cover is slid to a second position for exposing the connector via the opening.

4. The wireless local area network device as claimed in claim 3, further comprising an extensible spring having two ends fixed to the body and the cover, respectively, wherein the cover is in the second position when the extensible spring is not extended, and the cover is in the first position when the extensible spring is extended.

5. The wireless local area network device as claimed in claim 4, further comprising a locking means for fixing the cover on the body when the extensible spring is extended and the cover is slid to the first position.

6. The wireless local area network device as claimed in claim 5, further comprising a push button so that a pressing of the push button will cause the locking means to return the extensible spring to its original position, thereby sliding the cover to the second position for exposing the connector.

7. The wireless local area network device as claimed in claim 6, wherein the body has a slit for receiving the antenna.

8. The wireless local area network device as claimed in claim 7, wherein the slit has a hole formed therein to receive a push pin activated by the push button, so that, when the push button is pressed, the push pin is activated to push the antenna out of the slit.

9. The wireless local area network device as claimed in claim 8, wherein the body further includes a PCB electrically coupled to the revolving member and the connector.

10. The wireless local area network device as claimed in claim 1, which is a wireless adapter device.

11. The wireless local area network device as claimed in claim 1, which is a wireless access point.

12. A wireless local area network device, comprising:
a body including a PCB;
an antenna arranged at a rear part of the housing, and electrically coupled to the PCB;
a connector arranged at a front part of the housing, and electrically coupled to the PCB; and
a cover slidably connected to the housing, the cover having an opening, wherein when the cover is slid to a first position, the cover covers the connector, and when the cover is slid to a second position, the hole of the cover exposes the connector.

13. The wireless local area network device as claimed in claim 12, further comprising an extensible spring having two ends fixed to the body and the cover, respectively, wherein the cover is in the second position when the extensible spring is not extended, and the cover is in the first position when the extensible spring is extended.

14. The wireless local area network device as claimed in claim 13, further comprising a locking means for fixing the cover on the body when the extensible spring is extended and the cover is slid to the first position.

15. The wireless local area network device as claimed in claim 14, further comprising a push button so that a pressing of the push button will cause the locking means to return the extensible spring to its original position, thereby sliding the cover to the second position for exposing the connector.
